(19) United States
(12) Patent Application Publication
(10) Pub. No.: US 2013/0054224 A1
(43) Pub. Date: Feb. 28, 2013

(54) METHOD AND SYSTEM FOR ENHANCING TEXT ALIGNMENT BETWEEN A SOURCE LANGUAGE AND A TARGET LANGUAGE DURING STATISTICAL MACHINE TRANSLATION

(71) Applicants: JIE JIANG, Delph (GB); Jinhua Du, Xi'An (CN); Andrew Way, Oldham (GB)

(72) Inventors: JIE JIANG, Delph (GB); Jinhua Du, Xi'An (CN); Andrew Way, Oldham (GB)

(73) Assignee: DUBLIN CITY UNIVERSITY, Dublin (IE)

(21) Appl. No.: 13/599,312

(22) Filed: Aug. 30, 2012

Related U.S. Application Data
(60) Provisional application No. 61/529,005, filed on Aug. 30, 2011.

(51) Int. Cl. G06F 17/28

(52) U.S. Cl. 704/2

(57) ABSTRACT

A method for enhancing source-language coverage during statistical machine translation. The method including receiving an input string in a source language for translation into a target language. Extracting a paraphrase representation of the input string from a data repository comprising a corpus. Generating a word lattice structure using a directed acyclic graph representation having a plurality of nodes with edges extending there between. The words of the input string and the extracted paraphrase representation each having a respective edge in the directed acyclic graph. Labelling each of the edges with a word and a probability, the probability weighing assigned to the edges associated with the words of the input string being higher than the probability assigned to paraphrases derived from the input string.

### RELATED APPLICATION

The present invention claims priority from U.S. Provisional Patent Application No. 61/529,005, filed 30 Aug. 2012, the entirety of which is incorporated herein by reference.

### FIELD OF THE INVENTION

The present teaching relates to a method and system for enhancing source-language coverage during statistical machine translation (SMT). In particular, the teaching relates to encoding a word lattice or confusion network structure using an input string and paraphrases derived from the input string.

### BACKGROUND

Within the field of computational linguistics whereby computer software is used to translate from one language to another it is known to use statistical machine translation (SMT). SMT is a machine translation method where translations are generated on the basis of statistical models whose parameters are derived from the analysis of bilingual text corpora. In linguistics, a corpora is a large and structured set of texts. The corpora which may be electronically stored and processed facilitates statistical analysis and hypothesis testing such as checking occurrences or validating linguistic rules.

For efficient Statistical Machine Translation (SMT) systems, it is preferable to use a large parallel corpus for training the SMT system to ensure good translation quality. The term parallel corpora refers to a collection of texts in two languages. In order to exploit parallel corpora it is necessary to provide translation options between the two languages which identifies corresponding text segments between a target and a source language. There are many language segments that do not have sufficient corpora and as a consequence a translation option is not always possible. An inaccurate translation is generated when the SMT uses a corpora that has a sparse amount of parallel alignment corpus between a source and a target language.

There is therefore a need for a method for enhancing source-language coverage during statistical machine translation (SMT).

### SUMMARY

The present teaching relates to a system and method for enhancing source-language coverage during statistical machine translation (SMT). The method includes encoding a word lattice structure or confusion network using an input string and paraphrases derived from the input string.

Accordingly, a first embodiment of the teaching provides a method as detailed in claim 1. The teaching also provides a system as detailed in claim 12. Furthermore, the teaching relates to an article of manufacturer as detailed in claim 17. Advantageous embodiments are provided in the dependent claims.

These and other features will be better understood with reference to the followings Figures which are provided to assist in an understanding of the present teaching.

### BRIEF DESCRIPTION OF THE DRAWINGS

The present teaching will now be described with reference to the accompanying drawings in which:

FIG. 1 is a system for enhancing source-language coverage during statistical machine translation (SMT).

FIG. 2 is a work lattice representation derived from an input string applied to the system of FIG. 1.

FIG. 3 is an exemplary transformation implemented by the system of FIG. 1.

FIG. 4 is another system for enhancing source-language coverage during statistical machine translation (SMT).

FIG. 5 is a confusion network representation generated by the system of FIG. 4.

FIG. 6 are exemplary steps implemented by a detail of the system of FIG. 4.

### DETAILED DESCRIPTION OF THE DRAWINGS

The present teaching will now be described with reference to an exemplary system for enhancing source-language coverage during statistical machine translation (SMT) which is provided to assist in an understanding of the teaching of the invention.

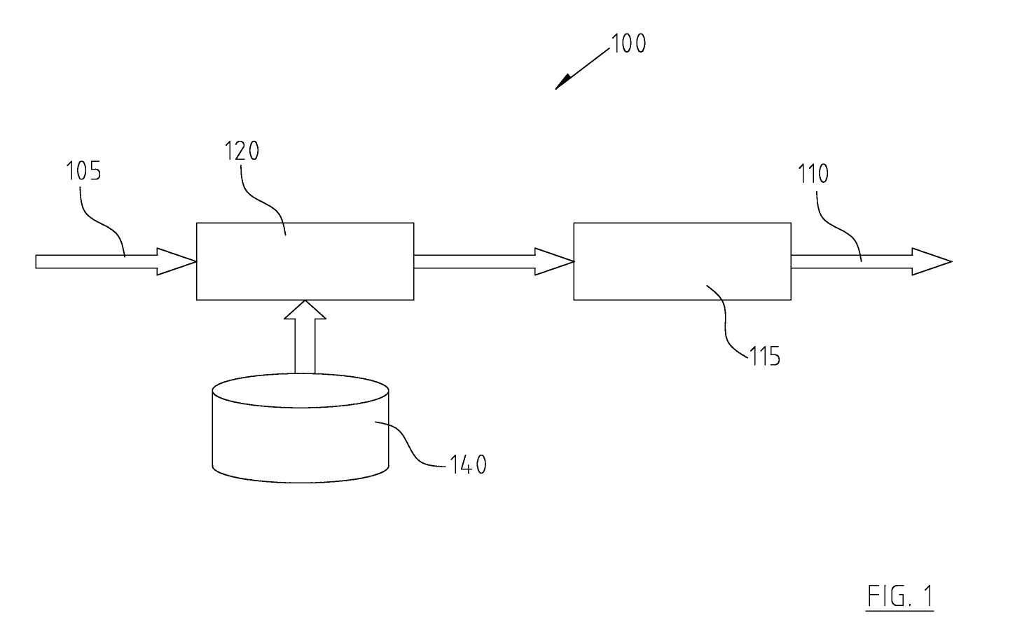

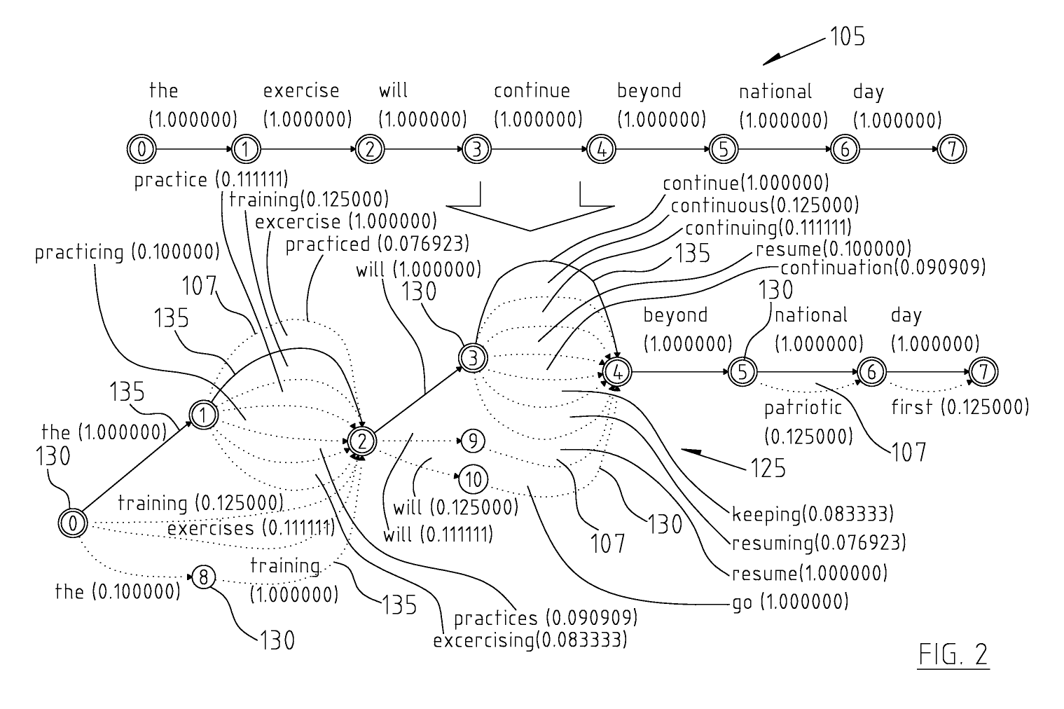

Referring initially to FIGS. 1 to 3 there is illustrated a system 100 for enhancing source-language coverage between a source language string 105 and a target language string 110 during statistical machine translation (SMT). A statistical machine translation (SMT) module 115 is provided which is configured to generate translations on the basis of statistical models whose parameters are derived from the analysis of bilingual text corpora. SMT modules are well known in the art and it is not intended to describe them further. A word lattice building module 120 is provided which generates a word lattice structure 125 using an input string 105 and paraphrases 107 derived from the input string 105. The word lattice structure 125 is a directed acyclic graph having a plurality of nodes 130 with respective edges 135 extending between the nodes 130. Word lattices are encoded by ordering the nodes 130 in a defined topology as illustrated in FIG. 2.

The word lattice building module 120 communicates with a paraphrase database 140 for extracting paraphrases 107 associated with the input string 105. The extracted paraphrases 107 are incorporated into the word lattice structure 125 by the word lattice building block 120. In the exemplary arrangement, the input string 105 contains the following sentence “the exercise will continue beyond national day”. The module 120 searches the database 140 for paraphrases/derivatives of each word contained in the input string 105. The database 140 contains the following paraphrases/derivatives for the word exercise: ‘practiced’, ‘exercise’, ‘training’, ‘practiced’, ‘practicing’, ‘practices’, and ‘exercising’. The database 140 contains the following paraphrases for the word continue: ‘continuous’, ‘continuing’, ‘resume’, ‘continuation’, keeping’, resuming’, resume’ and ‘go. The database 140 contains the following paraphrases for the word national: ‘patriotic’. Each paraphrase/derivative which is extracted from the database 140 is provided with a respective edge in the word lattice representation 125. The top part in FIG. 2 represents nodes (double-line circles) and edges (solid lines) that are constructed by the original words from the input string 105, while the bottom part in FIG. 2 indicates the final word lattice structure 125 which includes new nodes (single-line circles) and new edges (dashed lines) which come from the paraphrases 107 extracted from the database 140. It will be appreciated by those skilled in the art that the paraphrase lattices increases the diversity of the source phrases which may be aligned to target phrases during decoding by the SMT module 115. As a consequence, the system 100 enhances text alignment between a source language and a target language during statistical machine translation.

The present teaching may be applied to any system that can extract paraphrases from parallel or monolingual corpus. Specifically, parallel corpus can be used to extract paraphrases, which means that paraphrases are identified pivoting through phrases in another language. For example, the foreign language translations of an English phrase are identified, all occurrences of those foreign phrases are found, and all English phrases that they translate as are treated as potential paraphrases of the original English phrase. A paraphrase has a probability p(e₂|e₁) which is defined as in equation (1):

$$p ( {e}_{2} \vert {e}_{1} ) = {\sum }_{f} p ( f \vert {e}_{1} ) p ( {e}_{2} \vert f ) \qquad ( 1 )$$

where the probability p(f|e₁) is the probability that the original English phrase e₁ translates as a particular phrase f in the other language, and p(e₂|f) is the probability that the candidate paraphrase e₂ translates as the foreign language phrase. p(e₂|f) and p(f|e₁) are defined as the translation probabilities which can be calculated straightforwardly using maximum likelihood estimation by counting how often the phrases e and f are aligned in the parallel corpus as in equations (2) and (3):

$$\begin{matrix}p ( {e}_{2} \vert f ) \approx \frac{count ( {e}_{2} , f )}{{\sum }_{{e}_{2}} count ( {e}_{2} , f )} & ( 2 ) \\ p ( f \vert {e}_{1} ) \approx \frac{count ( f , {e}_{1} )}{{\sum }_{f} count ( f , {e}_{1} )} & ( 3 )\end{matrix}$$

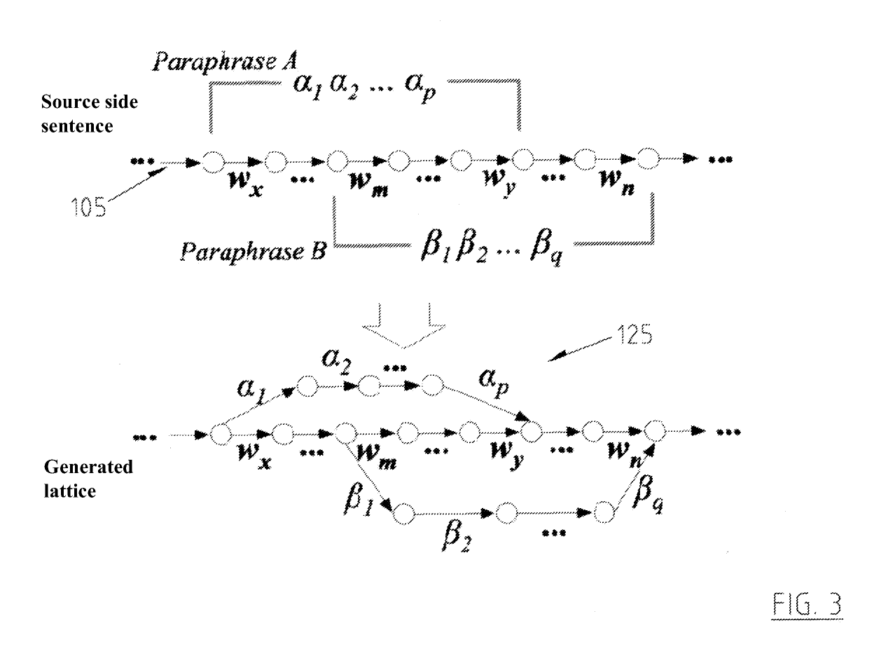

The word lattice building module 120 constructs word lattices from the input string 105 as illustrated in FIG. 3. The lattice building module 120 has a sequence of words {w₁, L, w_{N}} applied thereto as the input string. The module 120 is programmed so that for each of the paraphrase pairs found in the input string (e.g. {α₁, L, αₚ} for {wₓ, L, w_{y}}, and {β₁, L, β_{q}} for {wₘ, L, wₙ}), extra nodes and edges are added to the word lattice structure 125 to ensure that those phrases coming from paraphrases share the same start nodes and end nodes with that of the original words of the input string. The word lattice building module 120 is also programmed to assign weights on paraphrases edges in the word lattice structure 125. In the exemplary arrangement, edges originating from the original input string are assigned a weight of 1.0. The first edge for each of the paraphrases is calculated using equation 4:

$$w ( {e}_{{p}_{i}}^{1} ) = \frac{1}{k + i} , ( 1 \leq i \leq k ) \qquad ( 4 )$$

where superscript ‘1’ on the top of eₚ_{ᵢ}¹ for the first edge of paraphrase pᵢ, and i is the probability rank of pᵢ among those paraphrases sharing with a same start node, while k is a predefined constant as a trade-off parameter for efficiency and performance. The rest of the edges corresponding to the paraphrases are assigned weight 1.0. This weight calculation scheme is designed to penalise paths going through paraphrase edges during the decoding process by SMT module 115, while the penalisation level is decided by the normalized similarity empirical weight in equation 4 between the original word/phrase and the paraphrases.

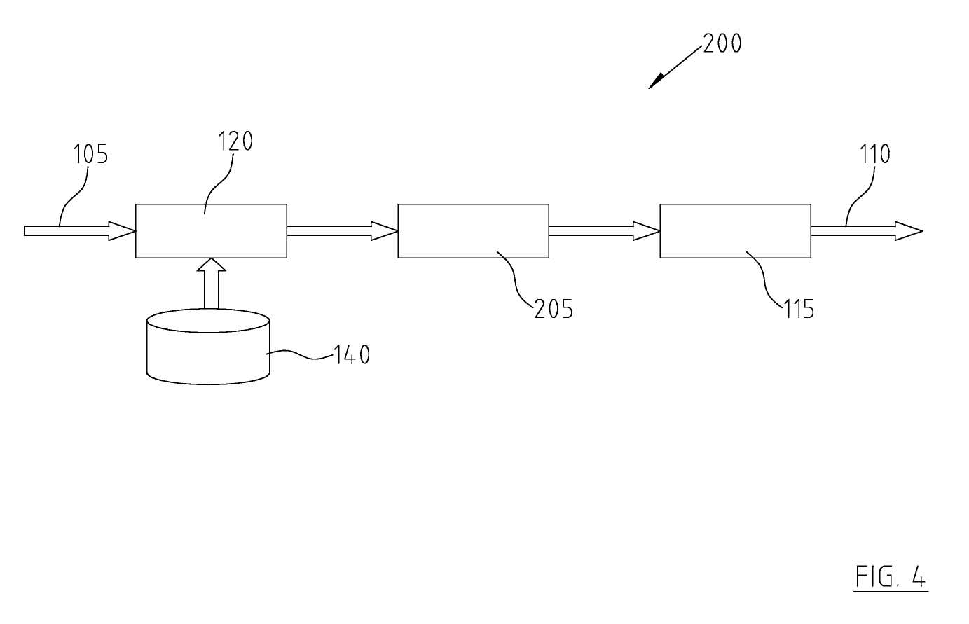

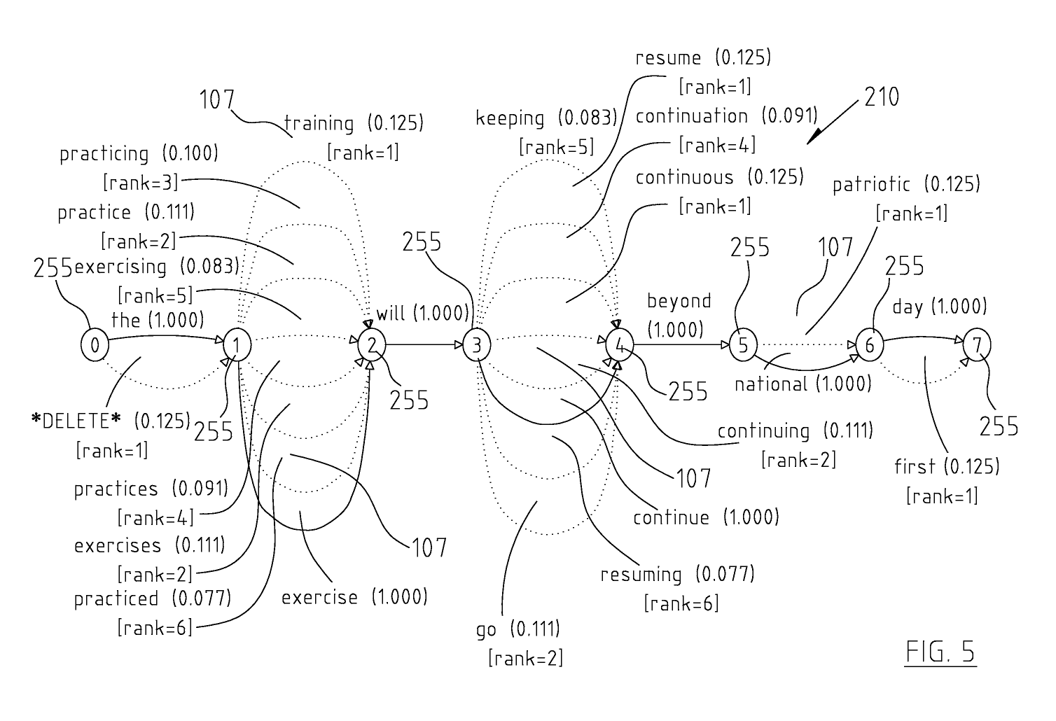

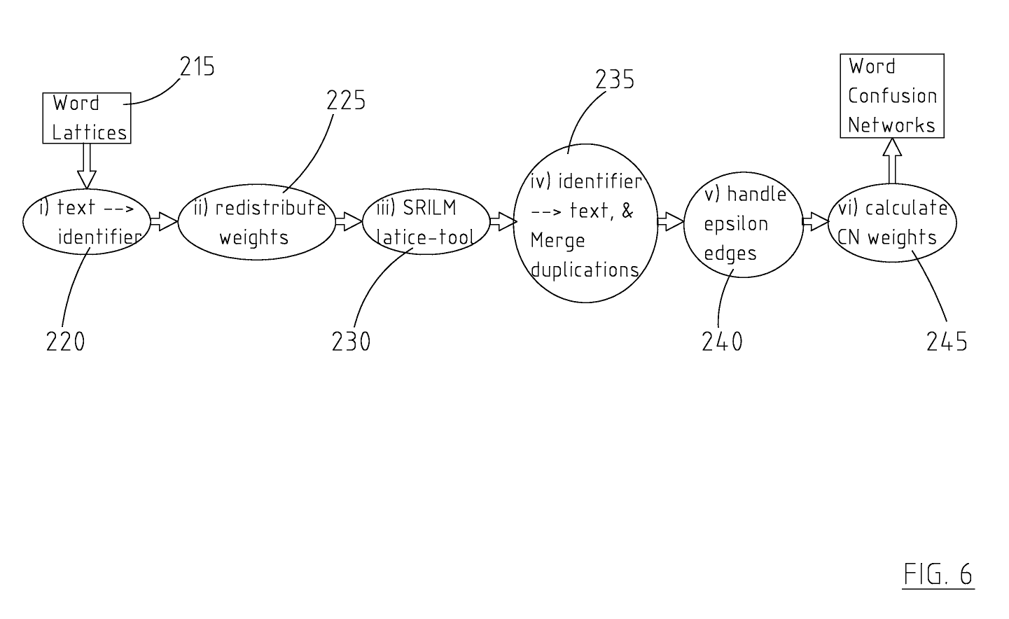

Referring now to FIGS. 4 to 6, there provided another system 200 for enhancing source-language coverage between a source language string 105 and a target language string 110 during statistical machine translation (SMT). The system 200 is substantially similar to the system 100 and like components are indicated by similar reference numerals. The main difference is that the system 200 includes an additional confusion networks (CN) module 205 for transforming the word lattice structure 125 into a confusion network representation 210 prior to being decoded by the SMT module 115. An exemplary transformation process implemented by the CN module 205 is illustrated in FIG. 6. The CN module 205 receives each word lattice from the wording lattice building module 120, step 215. The CN module 205 replaces word texts on edges with unique identifiers (e.g. edge indices), step 220. As a consequence, all the words in the word lattice are different from each other. Path penalties are evenly redistributed on paraphrase edges, step 225. The weight of eₚ_{ᵢ}¹ is defined as in equation 5:

$$w ( {e}_{{p}_{i}}^{j} ) = \frac{1}{\sqrt[{M}_{i}]{k + i}} , ( 1 \leq i \leq k ) \qquad ( 5 )$$

where eₚ_{ᵢ}^{j} is the j^{th} edge of paraphrase pᵢ, 1≦j≦Mᵢ, Mᵢ is the number of words in pᵢ, while k is a predefined constant.

In the word lattice structure 125, the path penalty for a paraphrase is represented by the weight of its first edge, while its succeeding edges are assigned the weight 1.0. Therefore step 225 evenly distributes the path penalties between paraphrase edges by averaging their weights for the following confusion network transformation step. The weighted word lattices are transformed into CNs with the lattice-tool in the Stanford Research Institute Language Modelling (SRILM) toolkit, and the paraphrase ranking information is carried on the edges for further processing, step 230. An SRILM is a toolkit for applying and creating statistical language models (LMs), typically for use in speech recognition, machine translation, statistical tagging and segmentation. SRILM is well known in the art and it is not intended to describe it further. It is not intended to limit the present teaching to SRILM as other language tools may also be used. Ranking indicates the index number of a paraphrase in a set of sorted paraphrases sharing the same start node on the lattice. The unique identifiers (created in the step 220) are replaced with original word texts, and then for each column of the CN, edges are merged with identical words by keeping those with the highest ranking (a smaller number indicates a higher ranking, and edges from the original sentences always have the highest ranking), step 235. Since ε edges do not appear in the original word lattice, ranking of paraphrase edges is used as an approximation: for all the paraphrase edges in the same column, the one with the closest posterior probability to that of the ε edge is found, and the ranking of that edge is assigned to the ε edge; if no such edge can be found which satisfies the previous criterion, ranking 1 is assigned to the ε edge, step 240. The edge weights in CNs are then reassigned, step 245. Edges from original sentences are assigned with weight 1.0, while edges from paraphrases are assigned with an empirical weight as in equation 6:

$$w ( {e}_{{p}_{i}}^{cn} ) = \frac{1}{\sqrt{k + i}} , ( 1 \leq i \leq k ) \qquad ( 6 )$$

where eₚ_{ᵢ}^{cn} are edges corresponding with paraphrase pᵢ, i is the ranking of pᵢ, and k is defined in equation 4. This empirical method is similar to the word-lattice-based method, and the aim is to penalise edges arising from paraphrases. However, one of the main differences between the word lattice structure 125 and the CN representation 210 is that for each of the paraphrases, all the related edges in the CN are carrying penalties while only the first edge in the word lattice has a penalty weight. In the CN representation 210 all of the nodes 255 in the CN are generated from the original input string 105, while solid-lined edges come from the original sentence, and dotted-lined edges correspond to paraphrases. Each edge from paraphrases is labelled with a word, an empirical weight and a ranking number, while the empirical weight is calculated from the ranking number by equation 6. Similar to word-lattice-based method, paths go through these edges are penalised according to the ranking of the corresponding paraphrase probabilities. Edges from the original input string always have weight 1.0 and are not penalised. It will therefore be appreciated by those skilled in the art that the probability weighting is biased towards the original words of the input string 105 compared to the extracted paraphrases 107. As a consequence, during the text alignment process carried out by the SMT module 115 the original words of the input string 105 have higher probability to be selected than the extracted paraphrases 107.

The advantages of the present teaching are numerous in particular the use of paraphrases to transform input sentences into word lattices or confusion networks for tuning and decoding purpose results in a more accurate translation. The system 100 seamlessly incorporates paraphrase information into the SMT system and obtains significant better performance. Moreover, the system 200 substantially reduces the decoding time while preserving the translation quality for large-scale translation tasks. To demonstrate the effectiveness and efficiency of the two systems 100 and 200, the following experiments were conducted on English-Chinese translation of three different sizes of training data: 20K, 200K and 2.1 million pairs of sentences. The former two corpora are derived from FBIS Multi-language Texts, and the latter corpus consists of part of Hong Kong parallel corpus, ISI Chinese-English Automatically Extracted Parallel Text data, other news data and parallel dictionaries from the Linguistic Data Consortium (LDC). All the language models are 5-gram which are trained on the monolingual part of parallel data with the lattice-tool in SRILM toolkit.

The development set (devset) and the test set for experiments using 20K and 200K data sets are randomly extracted from the FBIS data. Each set includes 1,200 sentences and each source sentence has one reference. For the 2.1 million data set, a different devset and test set were used in order to verify that the methods can work on a language pair with sufficient resources. The devset is the NIST 2005 Chinese-English current set which has only one reference for each source sentence and the test set is the NIST 2003 English-Chinese current set which contains four references for each source sentence. All results are reported in BLEU and TER scores. All the significance tests use bootstrap and paired-bootstrap resampling normal approximation methods, while improvements are considered to be significant if the left boundary of the confidence interval is larger than zero in terms of the “pair-CI 95%”.

For comparison, the experiment setup used Moses PBSMT as one baseline, and also a paraphrase substitution-based system (called “Para-Sub”) based on the translation model augmentation method as another baseline. The experiment compared the word-lattice-based and CN-based systems 100 and 200 with the two baselines in terms of automatic evaluation metrics. Experimental results are shown in Table I, II and III for 20K, 200K and 2.1 million data sets respectively. Furthermore, decoding time of baseline PBSMT, word-lattice-based and CN-based systems on three test sets are illustrated in Table IV. It was noted that the “Para-Sub” system had a similar decoding time with baseline PBSMT since only the translation table is modified. Moreover, by using the SRILM toolkit, the conversion time from word lattices into CNs is negligible compared with decoding time.

TABLE I
Table I. Comparison between the baseline, “Para-Sub”, “Lattice” (word-
lattice-based) and “CN” (confusion-network-based) method on a
small-sized data set.

| | 20K | | | |
|---|---|---|---|---|
| Sys | BLEU | CI 95% | Pair-CI 95% | TER |
| Baseline | 14.42 | [−0.81, +0.74] | — | 75.30 |
| Para-Sub | 14.78 | [−0.78, +0.82] | [+0.13, +0.60] | 73.75 |
| Lattice | 15.44 | [−0.85, +0.84] | [+0.74, +1.30] | 73.06 |
| CN | 14.73 | [−0.87, +0.89] | [+0.07, +0.57] | 73.80 |

TABLE II
Table II. Comparison between the baseline, “Para-Sub”, “Lattice” (word-
lattice-based) and “CN” (confusion-network-based) method on a
medium-sized data set.

| | 200K | | | |
|---|---|---|---|---|
| Sys | BLEU | CI 95% | Pair-CI 95% | TER |
| Baseline | 23.60 | [−1.03, +0.97] | — | 63.56 |
| Para-Sub | 23.41 | [−1.04, +1.00] | [−0.46, +0.09] | 63.84 |
| Lattice | 25.20 | [−1.11, +1.15] | [+1.19, +2.01] | 62.37 |
| CN | 23.47 | [−1.00, +1.01] | [−0.44, +0.17] | 63.69 |

TABLE III
Table III. Comparison between the baseline, “Para-Sub”, “Lattice” (word-
lattice-based) and “CN” (confusion-network-based) method on a
large-sized data set.

| | 2.1M | | | |
|---|---|---|---|---|
| Sys | BLEU | CI 95% | Pair-CI 95% | TER |
| Baseline | 14.04 | [−0.73, +0.40] | — | 74.88 |
| Para-Sub | 14.13 | [−0.56, +0.56] | [−0.18, +0.40] | 74.43 |
| Lattice | 14.55 | [−0.75, +0.32] | [+0.15, +0.83] | 73.28 |
| CN | 14.49 | [−0.53, +0.60] | [+0.17, +0.74] | 73.06 |

TABLE IV
Table IV. Decoding time comparison of the baseline PBSMT,
word-lattice-based (“Lattice”) and CN-based (“CN”) methods.

| | |
|---|---|
| FBIS testset | NIST testset |
| (1,200 inputs) | (1,859 inputs) |

| | | | |
|---|---|---|---|
| Sys | 20K model | 200K model | 2.1M model |

| | | | |
|---|---|---|---|
| Baseline | 21 min | 41 min | 37 min |
| Lattice | 102 min | 398 min | 559 min |
| CN | 48 min | 95 min | 116 min |

In Tables I, II and III, the 95% confidence intervals (CI) for BLEU scores are independently computed on each of the four systems, while the “pair-CI 95%”s are computed relative to the baseline system only for the “Para-Sub”, “Lattice” and “CN” systems. Moreover, comparing the “Lattice” system with the “Para-Sub” system, the “pair-CI 95%”s are [+0.44, +0.97], [+1.40, +2.17] for 20K and 200K data respectively. It indicates that for 20K and 200K data sets, although “Para-Sub” is significantly better than the baseline PBSMT, the word-lattice-based system is significantly better than both of them. Moreover, for the 2.1 million data set, “Para-Sub” system is insignificantly better than baseline PBSMT, while word-lattice-based system is significantly better than the baseline PBSMT. Thus the word-lattice-based system 100 obtains significantly better performance than all the baselines.

From Table III, the “CN” system 200 out performs the “Lattice” system 100 by 0.2 absolute (0.27% relative) TER points, while in terms of BLEU, the “pair-CI 95%” between the “Lattice” and the “CN” system is [−0.19, +0.38], which means that the “Lattice” system is insignificantly better than the “CN” system. However, in Table IV, CNs significantly reduce the decoding time of word lattices on three tasks, namely 52.94% for the 20K model, 76.13% for the 200K model and 79.25% for the 2.1 M model. Therefore, on large-sized corpus, the CN-based method significantly reduces the computational complexity while preserving the system performance of the best word-lattice-based method. Thus it makes the paraphrase-enriched SMT system more applicable to real-world applications. On the other hand, for small and medium-sized data, CNs can be used as a compromise between speed and quality, since decoding time is much less than with word lattices, and compared with the “Para-Sub” system, the only overhead is transforming the input sentences.

It will be understood that what has been described herein are exemplary SMT systems. While the present teaching has been described with reference to exemplary arrangements it will be understood that it is not intended to limit the teaching to such arrangements as modifications can be made without departing from the spirit and scope of the present teaching.

It will be understood that while exemplary features of the systems and methodology in accordance with the present teaching have been described that such an arrangement is not to be construed as limiting the invention to such features. A method of and a system for enhancing source-language coverage may be implemented in software, firmware, hardware, or a combination thereof. In one mode, a method of and a system for retrieving information is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. The arrangements of FIGS. 1-6 may be implemented by a server or computer in which the software modules 120, 115, and 205 reside or partially reside.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) may be programmed to perform the functions of the systems 100 and 200. The processor(s) is a hardware device for executing software, particularly software stored in memory. Processor(s) can be any custom made or commercially available processor, a central processing unit (CPU), an auxiliary processor among several processors associated with a computer, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc., or a 68xxx series microprocessor from Motorola Corporation. Processor(s) may also represent a distributed processing architecture such as, but not limited to, SQL, Smalltalk, APL, KLisp, Snobol, Developer 200, MUMPS/Magic.

Memory 140 is associated with processor(s) and is operable to receive data. Memory can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s).

The software may include one or more separate programs. The separate programs comprise ordered listings of executable instructions for implementing logical functions in order to implement the methods which are described above. In the example of heretofore described, the software includes the one or more components of the method of and a system for enhancing text alignment between a source language and a target language and is executable on a suitable operating system (O/S). A non-exhaustive list of examples of suitable commercially available operating systems is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). The operating system essentially controls the execution of other computer programs, such as the that provided by the present teaching, and provides scheduling, input-output control, file and data management, memory management, and communication control and related services.

The system provided in accordance with the present teaching may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

The I/O devices and components of the computer may include input devices, for example but not limited to, input modules for PLCs, a keyboard, mouse, scanner, microphone, touch screens, interfaces for various medical devices, bar code readers, stylus, laser readers, radio-frequency device readers, etc. Furthermore, the I/O devices may also include output devices, for example but not limited to, output modules for PLCs, a printer, bar code printers, displays, etc. Finally, the I/O devices may further include devices that communicate both inputs and outputs, for instance but not limited to, a modulator/demodulator (modem; for accessing another device, system, or network), a radio frequency (RF) or other transceiver, a telephonic interface, a bridge, and a router.

When the method of and system for enhancing source-language coverage may be implemented in software, it should be noted that such software can be stored on any computer readable medium for use by or in connection with any computer related system or method. In the context of this document, a computer readable medium is an electronic, magnetic, optical, or other physical device or means that can contain or store a computer program for use by or in connection with a computer related system or method. Such an arrangement can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

Any process descriptions or blocks in FIGS. 1-6, should be understood as representing modules, segments, or portions of code which include one or more executable instructions for implementing specific logical functions or steps in the process, as would be understood by those having ordinary skill in the art.

It should be emphasized that the above-described embodiments of the present teaching, particularly, any “preferred” embodiments, are possible examples of implementations, merely set forth for a clear understanding of the principles. Many variations and modifications may be made to the above-described embodiment(s) without substantially departing from the spirit and principles of the present teaching. All such modifications are intended to be included herein within the scope of this disclosure and the present invention and protected by the following claims.

Although certain example methods, apparatus, systems and articles of manufacture have been described herein, the scope of coverage of this application is not limited thereto. On the contrary, this application covers all methods, systems, apparatus and articles of manufacture fairly falling within the scope of the appended claims.

The words comprises/comprising when used in this specification are to specify the presence of stated features, integers, steps or components but does not preclude the presence or addition of one or more other features, integers, steps, components or groups thereof.

What we claim:

1. A method for enhancing source-language coverage during statistical machine translation (SMT), the method comprising:
receiving an input string in a source language for translation into a target language;
extracting a paraphrase representation of the input string from a data repository comprising a corpus,
generating a word lattice structure using a directed acyclic graph representation having a plurality of nodes with edges extending there between,
the words of the input string and the extracted paraphrase representation each having a respective edge in the directed acyclic graph,
labelling each of the edges with a word and a probability, the probability weighing assigned to the edges associated with the words of the input string being higher than the probability assigned to edges associated with the paraphrases derived from the input string.

2. A method as claimed in claim 1, wherein each paraphrase is assigned a probability p(e₂|e₁) defined by the equation:
$$p ( {e}_{2} \vert {e}_{1} ) = {\sum }_{f} p ( f \vert {e}_{1} ) p ( {e}_{2} \vert f ) \qquad ( 1 )$$
where the probability p(f|e₁) is the probability that the original phrase e₁ translates as a particular phrase f in another language, and p(e₂|f) is the probability that the candidate paraphrase e₂ translates as a foreign language phrase.

3. A method as claimed in claim 1, wherein the edges with words of the original input string are assigned a probability weighting of 1.

4. A method as claimed in claim 1, wherein the first edge for each paraphrase is defined by equation:
$$w ( {e}_{{p}_{i}}^{1} ) = \frac{1}{k + i} , ( 1 \leq i \leq k ) \qquad ( 4 )$$
where superscript ‘1’ on the top of eₚ_{ᵢ}¹ for the first edge of paraphrase pᵢ and i is the probability rank of pᵢ among those paraphrases sharing with a same start node, while k is a predefined constant as a trade-off parameter for efficiency and performance.

5. A method as claimed in claim 1, wherein the word lattice structure is input to a statistical machine translation module for decoding.

6. A method as claimed in claim 1, further comprising replacing word texts on edges with unique identifiers.

7. A method as claimed in claim 6, further comprising evenly distributing path penalties on paraphrase edges using the equation:
$$w ( {e}_{{p}_{i}}^{j} ) = \frac{1}{\sqrt[{M}_{i}]{k + i}} , ( 1 \leq i \leq k )$$
wherein eₚ_{ᵢ}^{j} is the j^{th} edge of paraphrase pᵢ, where 1≦j≦Mᵢ, Mᵢ is the number of words in pᵢ, while k is a predefined constant.

8. A method as claimed in claim 7, further comprising transforming the weighted word lattices into a confusion network representation.

9. A method as claimed in claim 8, wherein each edge associated with paraphrases in the confusion network representation is labelled with a word, an empirical weight and a ranking number.

10. A method as claimed in claim 9, further comprising merging edges with identical words by retaining those with the highest ranking thereby eliminating duplication.

11. A method as claimed in claim 10, wherein the confusion network representation is input to a statistical machine translation module for decoding.

12. A system for enhancing source-language coverage during statistical machine translation (SMT), the system comprising a word lattice building module programmed to perform the following functions:
receiving an input string in a source language for translation into a target language;
extracting a paraphrase representation of the input string from a data repository comprising a corpus,
generating a word lattice structure using a directed acyclic graph representation having a plurality of nodes with edges extending there between,
the words of the source string and the extracted paraphrase representation each having a respective edge in the directed acyclic graph,
labelling each of the edges with a word and a probability, the probability weighing assigned to the edges associated with the words of the input string being higher than the probability assigned to edges associated with paraphrases derived from the input string.

13. A system as claimed in claim 12, further comprising a confusion networks module programmed for transforming the word lattice structure into a confusion network representation.

14. A system as claimed in claim 13, wherein each edge associated with paraphrases in the confusion network representation is labelled with a word, an empirical weight and a ranking number.

15. A system as claimed in claim 14, further comprising merging edges with identical words by retaining those with the highest ranking thereby eliminating duplication.

16. A method as claimed in claim 13, further comprising a statistical machine translation module.

17. An article of manufacture storing machine readable instructions which, when executed, cause a machine to:
extract a paraphrase representation of an input string from a data repository comprising a corpus,
generate a word lattice structure using a directed acyclic graph representation having a plurality of nodes with edges extending there between,
the words of the input string and the extracted paraphrase representation each having a respective edge in the directed acyclic graph,
label each of the edges with a word and a probability, the probability weighing assigned to the edges associated with the words of the input string being higher than the probability assigned to edges associated with paraphrases derived from the input string.
